(19) United States
(12) Patent Application Publication
(10) Pub. No.: US 2015/0165874 A1
(43) Pub. Date: Jun. 18, 2015

(54) VENT DEVICE

(71) Applicant: Toyota Jidosha Kabushiki Kaisha, Toyota-shi, JP (US)

(72) Inventors: Hirotaka Kawano, Toyota-shi (JP); Hideaki Ryuse, Toyota-shi (JP)

(21) Appl. No.: 14/566,127

(22) Filed: Dec. 10, 2014

(30) Foreign Application Priority Data
Dec. 17, 2013 (JP) 2013-260237

(51) Int. Cl. B60H 1/24

(52) U.S. Cl. CPC B60H 1/249

(57) ABSTRACT

A vent device has: a vent duct having a vent opening for communicating between the inside of the vehicle and the outside of the vehicle; and a flap attached to the vent duct and being able to open and close the vent opening. In the vent device, an electromagnet is disposed in a lower section of a peripheral edge of the vent opening in the vent duct, and an iron plate is disposed in a lower section of the flap. These electromagnet and iron plate constitute a suppression mechanism. In the vent device, when a possibility that a vehicle door is opened or closed is low, the electromagnet is brought into an energized state by a controller, and opening of the vent opening is suppressed. When the possibility that the vehicle door is opened or closed is high, the electromagnet is brought into an unenergized state by the controller.

### INCORPORATION BY REFERENCE

The disclosure of Japanese Patent Application No. 2013-260237 filed on Dec. 17, 2013 including the specification, drawings and abstract is incorporated herein by reference in its entirety.

### BACKGROUND OF THE INVENTION

1. Field of the Invention

The present invention relates to a vent device.

2. Description of Related Art

A vent device described in Japanese Patent Application Publication No. 04-185525 (JP 04-185525 A) includes: a vent duct having a vent opening for communicating between the inside of a vehicle and the outside of the vehicle; and an opening/closing member that is attached to the vent opening in an openable and closable manner. In this vent device, the opening/closing member is formed of a rubber sheet containing hard ferrite, and the vent duct having the vent opening is formed of plastic containing soft ferrite. Then, magnetism of each of these constituents is used to tightly contact the opening/closing member to the vent duct, so as to suppress the opening/closing member from unnecessarily separating from the vent duct, which causes opening of the vent opening. In this way, in the vent device described in JP 04-185525 A, penetration of noise, such as tire noise and exhaust sound from a muffler on the outside of the vehicle, from the outside of the vehicle to the inside of the vehicle during traveling is suppressed.

By the way, in the vent device disclosed in JP 04-185525 A, the opening/closing member, which is formed of the rubber sheet containing hard ferrite, and the vent duct, which is formed of plastic containing soft ferrite, tightly contact each other by using the magnetism of these constituents. Thus, in the vent device disclosed in JP 04-185525 A, stress for suppressing the opening of the vent opening remains constant, and thus it is difficult to open the vent opening at appropriate timing

### SUMMARY OF THE INVENTION

The present invention provides a vent device that can open a vent opening at appropriate timing.

A vent device according to an aspect of the present invention includes: a vent duct that has a vent opening for communicating between the inside of a vehicle and the outside of the vehicle; an opening/closing member that is attached to the vent duct and open and close the vent opening; a suppression mechanism that suppresses opening of the vent opening; and a controller that controls the suppression mechanism.

According to the above aspect, the suppression mechanism can be controlled by the controller. For example, it is possible to switch between a state that opening of the vent opening is suppressed and a state that the opening of the vent opening is not suppressed. Thus, the vent opening can be opened at appropriate timing.

Noted that, when a vehicle door is opened or closed, the air needs to be discharged from the inside of the vehicle to the outside of the vehicle through the vent opening for a purpose of easy closing of the vehicle door and the like. On the contrary, if stress for suppressing the opening of the vent opening remains constant, the air is unlikely to be discharged from the inside of the vehicle to the outside of the vehicle upon opening or closing of the vehicle door.

In the above aspect, the suppression mechanism may be configured that an electromagnet is disposed in one of a peripheral edge of vent opening in the vent duct and a portion of the opening/closing member that abuts against the peripheral edge and that a ferromagnetic body is disposed in another thereof, and the controller may suppress the opening of the vent opening by energizing the electromagnet.

According to the above aspect, when the possibility that the vehicle door is opened or closed is low, a magnetic field of the electromagnet magnetizes the ferromagnetic body, and the electromagnet and the ferromagnetic body are attracted to each other. In this way, the opening of the vent opening is suppressed. On the other hand, when the possibility that the vehicle door is opened or closed is high, an action by such a magnetic field is not generated, and the electromagnet and the ferromagnetic body easily separate from each other. Thus, the opening/closing member separates from the vent opening in accordance with a flow of the air, and the vent opening is easily opened. In other words, according to the above configuration, the state that the opening of the vent opening is suppressed and the state that the opening of the vent opening is not suppressed can be switched through the energization control of the electromagnet.

In the above aspect, the controller may control the suppression mechanism to suppress the opening of the vent opening when a vehicle speed is at least equal to a specified speed, in comparison with a case where the vehicle speed is lower than the specified speed.

During traveling, a possibility that the vehicle door is opened or closed is low. In the above configuration, the vehicle speed is checked, and the opening of the vent opening is selectively suppressed under a condition that the vehicle speed is at least equal to the specified speed and thus it is estimated that the vehicle is traveling. Thus, it is possible to concurrently realize the suppression of the penetration of the noise during traveling from the outside of the vehicle to the inside of the vehicle, which is realized by suppressing the opening of the vent opening at the appropriate timing, and the discharge of the air on the inside of the vehicle to the outside of the vehicle through the vent opening upon the opening and closing of the vehicle door.

In the above aspect, the controller may control the suppression mechanism to suppress the opening of the vent opening when the vehicle door is in a locked state, in comparison with a case where the vehicle door is in an unlocked state.

When the vehicle door is in the locked state, the possibility that the vehicle door is opened or closed is low. In the above configuration, the locked state of the vehicle door is checked, and the opening of the vent opening is selectively suppressed under a condition that the vehicle door is in the locked state and thus it is estimated that the possibility that the vehicle door is opened or closed is low. Thus, it is possible to concurrently realize the suppression of the penetration of the noise during traveling from the outside of the vehicle to the inside of the vehicle, which is realized by suppressing the opening of the vent opening at the appropriate timing, and the discharge of the air on the inside of the vehicle to the outside of the vehicle through the vent opening upon the opening and closing of the vehicle door.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a side view of a vehicle that includes a vent device;

FIG. 2 is a perspective view of a vent assy attached to a vehicle body;

FIG. 3 is a cross-sectional view taken along the 3-3 line in FIG. 2;

FIG. 4 is a flowchart for illustrating a processing procedure of energization control; and

FIG. 5 is a cross-sectional view of the vent assy in a state that a vent opening is opened.

### DETAILED DESCRIPTION OF EMBODIMENTS

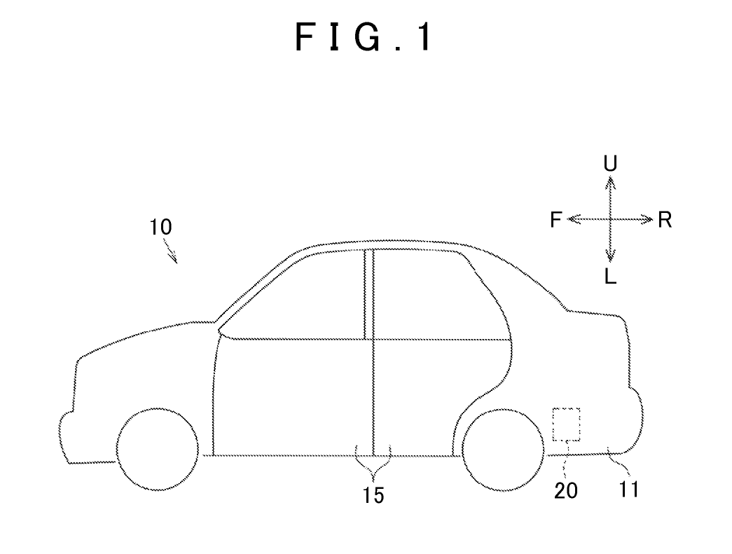

A description will hereinafter be made on an embodiment of a vent device with reference to FIG. 1 to FIG. 5. Noted that, in each of FIG. 1 to FIG. 3 and FIG. 5, a front side of a vehicle is indicated by an arrow F, a rear side of the vehicle is indicated by an arrow R, an upper side of the vehicle is indicated by an arrow U, and a lower side of the vehicle is indicated by L.

As shown in FIG. 1, a vent device 20 that discharges the air on the inside of the vehicle to the outside of the vehicle is provided at the rear of a vehicle door 15 of a vehicle 10, the air on the inside of the vehicle flowing from the front side to the rear side of the vehicle 10. Noted that, since the vent device 20 cannot be visually recognized from external appearance of the vehicle 10, a disposed position of the vent device 20 is indicated by a broken line in FIG. 1.

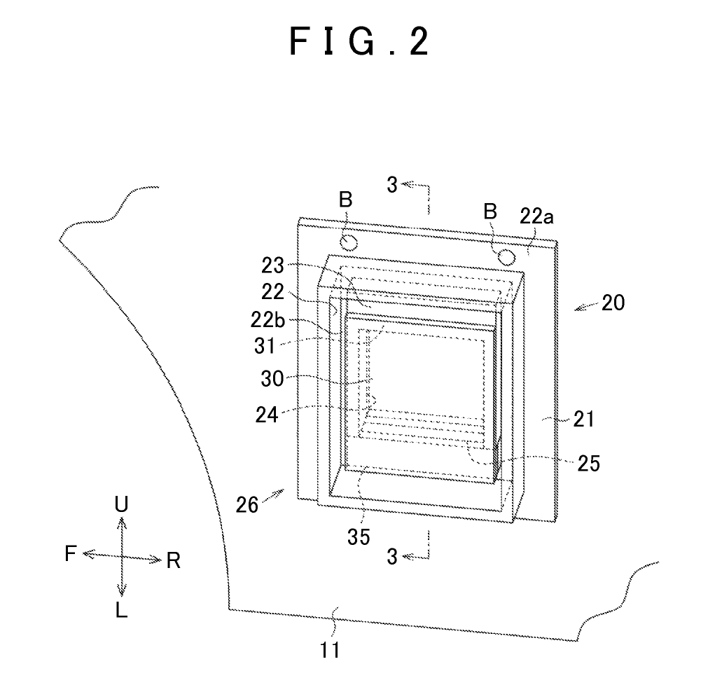

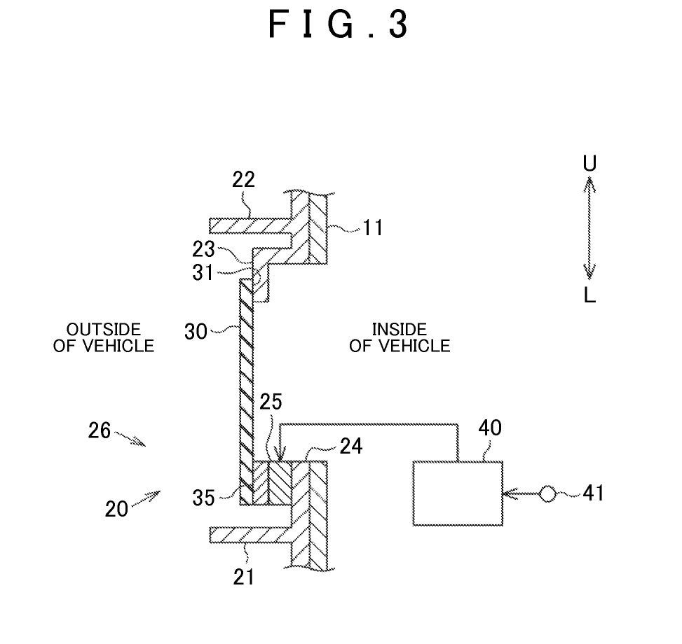

As shown in FIG. 2 and FIG. 3, the vent device 20 has a vent assy 21 that is configured by including: a vent duct 22 having a vent opening 24 for communicating between the inside of the vehicle and the outside of the vehicle; and a rubber-made flap 30 as an opening/closing member that is attached to the vent duct 22 so as to be able to open and close the vent opening 24.

As shown in FIG. 2, a framework of the vent assy 21 is formed by the vent duct 22 in a bottomed rectangular-cylindrical shape that opens to the outside of the vehicle. In the vent duct 22, a flange 22a as a peripheral edge thereof is attached to a body 11 by a bolt B, and the vent opening 24 that opens in a rectangular shape is formed at the center in a bottom thereof. Of a peripheral edge 22b of the vent opening 24 in the vent duct 22, an electromagnet 25 is disposed in a lower section of the peripheral edge 22b of the vent opening 24. Noted that the vent duct 22 is attached to the body 11 in a manner that the vent opening 24 and an opening that is formed in a lateral surface of the body 11 communicate with each other. In this way, the inside of the vehicle and the outside of the vehicle is communicated by the vent opening 24 of the vent duct 22.

The flap 30 is rectangular shaped and slightly larger than the vent opening 24 in size. Then, an adhesion section 31 in an upper section of the flap 30 is adhered to an attachment section 23 that is in the peripheral edge 22b of the vent opening 24 of the vent duct 22 and that is positioned in an upper section of the vent opening 24. Since the flap 30 is attached to the vent duct 22, just as described, the flap 30 covers the vent opening 24 from the outside of the vehicle. In addition, an iron plate 35 as a ferromagnetic body is disposed in a lower section of the flap 30. More specifically, the lower section of the flap 30 and the peripheral edge 22b in a lower section of the vent opening 24 in the vent duct 22 can abut against each other via the iron plate 35 and the electromagnet 25, and this iron plate 35 and the electromagnet 25 constitute a suppression mechanism 26.

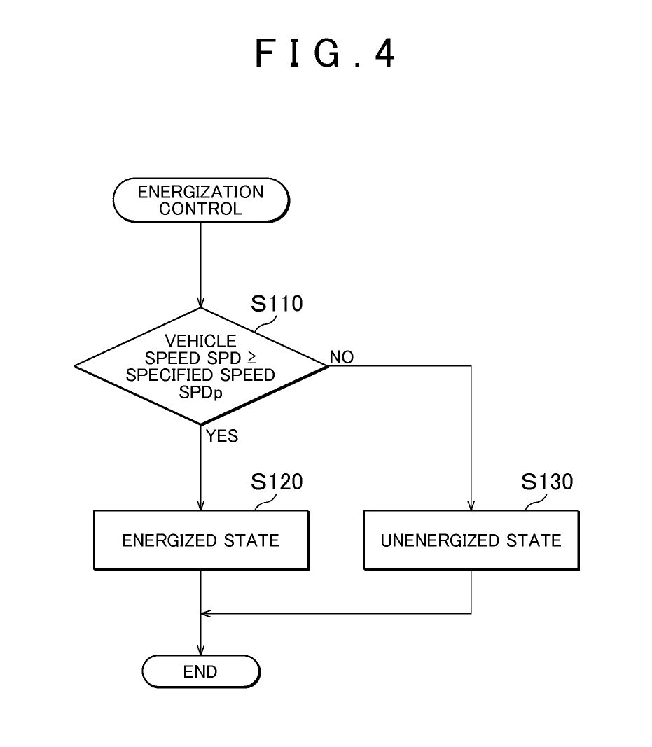

As shown in FIG. 3, the electromagnet 25, which constitutes the suppression mechanism 26, is connected to a controller 40 that functions as a part of the vent device 20. The controller 40 receives an output signal from a vehicle speed sensor 41 for detecting a vehicle speed (a vehicle speed SPD) of the vehicle 10 at a present moment. Then, based on this output signal from the vehicle speed sensor 41, energization control for switching between an energized state and an unenergized state of the electromagnet 25 is executed in the controller 40. The energization control of the electromagnet 25, which is executed by the controller 40, will hereinafter be described with reference to a flowchart in FIG. 4. Noted that this energization control is repeatedly executed by the controller 40 at specified intervals.

As shown in FIG. 4, in the energization control, it is determined on the basis of the output signal from the vehicle speed sensor 41 whether the vehicle speed SPD is at least equal to a specified speed SPDp (step S110). If it is determined that the vehicle speed SPD is at least equal to the specified speed SPDp (step S110: YES), a possibility that the vehicle door 15 is opened or closed is considered to be low, and thus the electromagnet 25 is brought into the energized state (step S120). In other words, in this step S120, if the electromagnet 25 is in the unenergized state, the electromagnet 25 is switched from the unenergized state to the energized state. On the other hand, if the electromagnet 25 is in the energized state, the electromagnet 25 remains in the energized state. Then, the control is terminated once.

On the other hand, if it is determined that the vehicle speed SPD is lower than the specified speed SPDp (step S110: NO), the possibility that the vehicle door 15 is opened or closed is considered to be high, and thus the electromagnet 25 is brought into the unenergized state (step S130). In other words, in this step S130, if the electromagnet 25 is in the energized state, the electromagnet 25 is switched from the energized state to the unenergized state. On the other hand, if the electromagnet 25 is in the unenergized state, the electromagnet 25 remains in the unenergized state. Then, the control is terminated once. Noted that “5 km/h” is used for the specified speed SPDp, for example.

Next, the action of this vent device 20 will be described. When it is determined by the above energization control that the vehicle speed SPD is at least equal to the specified speed SPDp, the electromagnet 25 is brought into the energized state. Accordingly, a magnetic field of the electromagnet 25 magnetizes the iron plate 35, and the electromagnet 25 and the iron plate 35 are attracted to each other. In this way, the flap 30 approaches in a direction to close the vent opening 24. Then, as shown in FIG. 3, the electromagnet 25 of the vent duct 22 and the iron plate 35 of the flap 30 tightly contact each other and bring the vent opening 24 into a closed state by the flap 30. In other words, when the vehicle speed SPD is at least equal to the specified speed SPDp, the opening of the vent opening 24 is suppressed by the electromagnet 25 and the iron plate 35 that are the suppression mechanism 26.

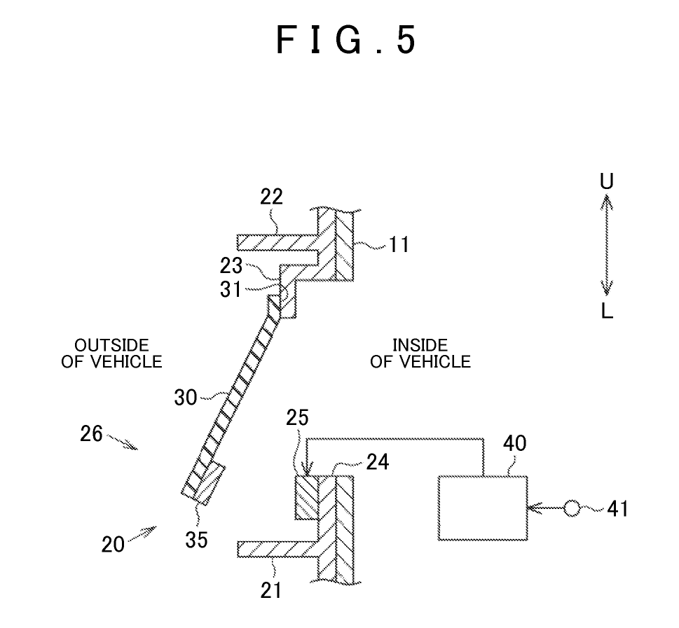

When it is determined by the above energization control that the vehicle speed SPD is lower than the specified speed SPDp, the electromagnet 25 is brought into the unenergized state. Accordingly, the above action by the magnetic field of the electromagnet 25 is not generated, and the electromagnet 25 and the iron plate 35 are easily separated from each other. In a state that the electromagnet 25 and the iron plate 35 are easily separated from each other, just as described, if the vehicle door 15 of the vehicle 10 is closed and a pressure of the air on the inside of the vehicle is increased to be at least equal to a specified pressure, the flap 30 is elastically deformed in accordance with a flow of the air from the inside of the vehicle to the vent opening 24. In this way, as shown in FIG. 5, the flap 30 separates from the vent opening 24, and thus the vent opening 24 is easily opened. Therefore, the air on the inside of the vehicle is easily discharged to the outside of the vehicle via the vent opening 24.

When the vehicle speed SPD is at least equal to the specified speed SPDp, that is, during traveling of the vehicle 10, the possibility that the vehicle door 15 is opened or closed is low. In this vent device 20, when the possibility that such a vehicle door 15 is opened or closed is low, the opening of the vent opening 24 can be suppressed.

On the other hand, when the vehicle speed SPD is lower than the specified speed SPDp, that is, during stop of the vehicle 10 or immediately before the vehicle 10 stops, the possibility that the vehicle door 15 is opened or closed is high. In this vent device 20, when the possibility that such a vehicle door 15 is opened or closed is high, the vent opening 24 can easily be opened.

In addition, the electromagnet 25 is switched between the energized state and the unenergized state in accordance with whether the vehicle speed SPD is at least equal to the specified speed SPDp. Accordingly, when the possibility that the vehicle door 15 is opened or closed is low, the opening of the vent opening 24 is suppressed in comparison with a case where the possibility that the vehicle door 15 is opened or closed is high.

The following effects can be exerted by the above-described vent device 20. (1) The controller 40 can switch between a state that the opening of the vent opening 24 is suppressed and a state that the opening of the vent opening 24 is not suppressed. Thus, the vent opening 24 can be opened at appropriate timing

(2) When the possibility that the vehicle door 15 is opened or closed is low, the electromagnet 25 is brought into the energized state, and the opening of the vent opening 24 can be suppressed. Thus, penetration of noise during traveling from the outside of the vehicle to the inside of the vehicle can be suppressed. In addition, when the possibility that the vehicle door 15 is opened or closed is low, the opening of the vent opening 24 is selectively suppressed in the vent device 20. Accordingly, when the possibility that the vehicle door 15 is opened or closed is high, the vent opening 24 is easily opened. Thus, the vent opening 24 can be opened at such appropriate timing that the vehicle door 15 is opened or closed, and the air on the inside of the vehicle can be discharged to the outside of the vehicle through the vent opening 24.

(3) When the possibility that the vehicle door 15 is opened or closed is low, the electromagnet 25 and the iron plate 35 are attracted to each other. Thus, the opening of the vent opening 24 is suppressed. On the other hand, when the possibility that the vehicle door 15 is opened or closed is high, the electromagnet 25 and the iron plate 35 easily separate from each other. Thus, the flap 30 separates from the vent opening 24 in accordance with the flow of the air, and the vent opening 24 is easily opened. In other words, according to the vent device 20, the state that the opening of the vent opening 24 is suppressed and the state that the opening of the vent opening 24 is not suppressed can be switched through the energization control of the electromagnet 25.

The controller 40 may control the suppression mechanism 26 to suppress the opening of the vent opening 24 when a vehicle speed SPD is at least equal to a specified speed SPDp, in comparison with a case where the vehicle speed SPD is lower than the specified speed SPDp.

(4) During traveling, the possibility that the vehicle door 15 is opened or closed is low. In the vent device 20, the vehicle speed SPD is checked, and the opening of the vent opening 24 is selectively suppressed under a condition that the vehicle speed SPD is at least equal to the specified speed SPDp and thus it is estimated that the vehicle is traveling. Thus, it is possible to concurrently realize the suppression of the penetration of the noise during traveling from the outside of the vehicle to the inside of the vehicle, which is realized by suppressing the opening of the vent opening 24 at the appropriate timing, and the discharge of the air on the inside of the vehicle to the outside of the vehicle through the vent opening 24 upon the opening and closing of the vehicle door 15.

Noted that the above-described embodiment can be modified and carried out as described below. •The opening of the vent opening 24 may be suppressed when the vehicle door 15 is in a locked state, in comparison with a case where the vehicle door 15 is in an unlocked state. In this embodiment, in the energization control shown in FIG. 4, it is determined in step S110 whether the vehicle door 15 is in the locked state. Then, if it is determined that the vehicle door 15 is in the locked state, the possibility that the vehicle door 15 is opened or closed is considered to be low, and the electromagnet 25 is brought into the energized state in step S120. Thus, the opening of the vent opening 24 is suppressed. On the other hand, if it is determined that the vehicle door 15 is in an unlocked state, the possibility that the vehicle door 15 is opened or closed is considered to be high, and the electromagnet 25 is brought into the unenergized state in step S130. Thus, the vent opening 24 is easily opened. According to such an embodiment, the following effects can be exerted, in addition to the effects (1) to (3), which can be obtained from the above-described embodiment.

(5) When the vehicle door 15 is in the locked state, the possibility that the vehicle door 15 is opened or closed is low. In the above modified embodiment, the locked state of the vehicle door 15 is checked, and the opening of the vent opening 24 is selectively suppressed under a condition that the vehicle door 15 is in the locked state and thus it is estimated that the possibility that the vehicle door 15 is opened or closed is low. Thus, it is possible to concurrently realize the suppression of the penetration of the noise during traveling from the outside of the vehicle to the inside of the vehicle, which is realized by suppressing the opening of the vent opening 24 at the appropriate timing, and the discharge of the air on the inside of the vehicle to the outside of the vehicle through the vent opening 24 upon the opening and closing of the vehicle door 15.

•The determination on the possibility that the vehicle door 15 is opened or closed may be made on the basis of a determination other than the determination on whether the vehicle speed SPD is at least equal to the specified speed SPDp as in the above embodiment and the determination on whether the vehicle door 15 is in the locked state as in the above modified embodiment. For example, the possibility that the vehicle door 15 is opened or closed may be determined on the basis of a determination on whether a seatbelt is in a locked state. In this embodiment, if the seatbelt is worn, and thus it is determined that the seatbelt is in the locked state, it is determined that the possibility that the vehicle door 15 is opened or closed is low. On the other hand, if the seatbelt is not worn, and thus it is determined that the seatbelt is in an unlocked state, it is determined that the possibility that the vehicle door 15 is opened or closed is high. In addition, the possibility that the vehicle door 15 is opened or closed may be determined on the basis of a determination by a navigation system on whether the vehicle 10 has arrived at a destination. In this embodiment, if it is determined that the vehicle 10 has not arrived at the destination, it is determined that the possibility that the vehicle door 15 is opened or closed is low. On the other hand, if it is determined that the vehicle 10 has arrived at the destination, it is determined that the possibility that the vehicle door 15 is opened or closed is high. Furthermore, the possibility that the vehicle door 15 is opened or closed may be determined on the basis of a determination on whether an engine has been changed from an ON state to an OFF state. In this embodiment, if it is determined that the engine has not been changed from the ON state to the OFF state, such as a case where the engine remains in the ON state, it is determined that the possibility that the vehicle door 15 is opened or closed is low. On the other hand, if it is determined that the engine has been changed from the ON state to the OFF state, it is determined that the possibility that the vehicle door 15 is opened or closed is high.

•The flap 30 may be made of a material other than rubber, such as metal. •The entire flap 30 may be made of iron, and the iron plate 35 may not be disposed on the flap 30.

•As in the above modified embodiment, particularly when the material other than rubber is adopted as the material of the flap 30, it is desirable that, instead of the adhesion by the adhesion section 31, a support member for supporting the flap 30 is used to attach the flap 30 to the vent duct 22 so that the vent opening 24 can be opened or closed.

•The iron plate 35 may be disposed on the peripheral edge 22b of the vent opening 24 of the vent duct 22, and the electromagnet 25 may be disposed on a portion of the flap 30 that abuts against the iron plate 35. Noted that, when the vent duct 22 is made of iron, the iron plate 35 on the peripheral edge 22b of the vent opening 24 of the vent duct 22 is not provided, and the electromagnet 25 on the flap 30 can directly and tightly contact the vent duct 22.

•The ferromagnetic body other than iron, such as nickel, may be disposed at a position on the flap 30 or on the peripheral edge 22b of the vent opening 24 of the vent duct 22 that abuts against the electromagnet 25, and the controller 40 may suppress the opening of the vent opening 24 by energizing the electromagnet 25. •The vent opening 24 may be in a shape other than the rectangular shape, such as a circular shape.

•The flap 30 may be in a shape other than the rectangular shape, such as a circular shape. •The vent duct 22 may be in a shape other than the bottomed rectangular-cylindrical shape, such as a bottomed cylindrical shape. •The vent duct 22 may be in a tubular shape. In these embodiments, since the size of the vent opening 24 becomes larger than that in the above embodiment, the size of the flap 30 is appropriately changed in accordance with the size of the vent opening 24.

•The vent duct 22 may be attached to the body 11 of the vehicle 10 by a means other than fastening by the bolt B, such as welding. •The example has been shown in which the suppression mechanism 26 that suppresses the opening of the vent opening 24 is configured by including the ferromagnetic bodies, such as the electromagnet 25 and the iron plate 35. However, the configuration of the suppression mechanism 26 can appropriately be modified as long as the configuration allows the suppression of the opening of the vent opening 24. For example, a motor may be adopted as the suppression mechanism 26. According to such a suppression mechanism 26, displacement of the flap 30 in a direction to separate from the vent opening 24 is suppressed by output of the motor. Thus, the opening of the vent opening 24 can be suppressed. In addition, an airflow generation mechanism may be adopted as the suppression mechanism 26. According to such a suppression mechanism 26, a flow of the air from the outside of the vehicle to the inside of the vehicle is generated in the vicinity of the vent opening 24. In this way, the displacement of the flap 30 in the direction to separate from the vent opening 24 is suppressed, and thus the opening of the vent opening 24 can be suppressed.

•As a vehicle door, a rear door of a hatchback vehicle may be included in addition to the vehicle door 15 for getting ON/OFF. When such a rear door is opened or closed, the air needs to be discharged from the inside of the vehicle to the outside of the vehicle through the vent opening 24 for a purpose of easy closing of the rear door and the like. Accordingly, when a possibility that such a rear door is opened or closed is low, the suppression mechanism 26 may be controlled such that the opening of the vent opening 24 is suppressed in comparison with a case where the possibility that the rear door is opened or closed is high. According to such an embodiment, the air on the inside of the vehicle can be discharged to the outside of the vehicle through the vent opening 24 when the rear door is opened or closed.

What is claimed is:

1. A vent device comprising:
a vent duct that has a vent opening for communicating between inside of a vehicle and outside of the vehicle;
an opening/closing member that is attached to the vent duct and open and close the vent opening;
a suppression mechanism that suppresses opening of the vent opening; and
a controller that controls the suppression mechanism.

2. The vent device according to claim 1, wherein
when a possibility that a vehicle door is opened or closed is low, the controller controls the suppression mechanism such that the opening of the vent opening is suppressed in comparison with a case where the possibility that the vehicle door is opened or closed is high.

3. The vent device according to claim 2, wherein
the suppression mechanism is configured that an electromagnet is disposed in one of a peripheral edge of the vent opening in the vent duct and a portion of the opening/closing member that abuts against the peripheral edge and that a ferromagnetic body is disposed in another thereof, and
the controller suppresses the opening of the vent opening by energizing the electromagnet.

4. The vent device according to claim 2, wherein
the controller controls the suppression mechanism to suppress the opening of the vent opening when a vehicle speed is at least equal to a specified speed, in comparison with a case where the vehicle speed is lower than the specified speed.

5. The vent device according to claim 2, wherein
the controller controls the suppression mechanism to suppress the opening of the vent opening when the vehicle door is in a locked state, in comparison with a case where the vehicle door is in an unlocked state.
